(19) United States
(12) Patent Application Publication
(10) Pub. No.: US 2007/0043246 A1
(43) Pub. Date: Feb. 22, 2007

(54) Conversion of sludges and carbonaceous materials

(76) Inventor: Trevor Bridle, Perth (AU)

Correspondence Address: Brian Kinnear;Holland & Hart, 555 17th Street, Suite 3200, Denver, CO, 80201-8749, US

(21) Appl. No.: 10/526,714

(22) PCT Filed: Aug. 26, 2003
(86) PCT No.: PCT/AU03/01099

§ 371 Date: Aug. 18, 2006

(30) Foreign Application Priority Data
Sep. 4, 2002 (AU) 2002951194

(51) Int. Cl. C01B 31/02; C10B 7/00

(52) U.S. Cl. 585/240; 423/445 R; 202/117; 48/111

(57) ABSTRACT

A process for the conversion of sludges and carbonaceous materials, the process characterised by the steps of: (a) Heating the material to be converted in a heating zone of a reactor in the absence of oxygen for the volatilisation of oil producing vapours, thereby producing both a vapour product and a solid residue or char, (b) Contacting the vapour product and char in a reaction zone of the reactor at a determined Weight Hour Space Velocity (“WHSV”) so as to promote vapour-phase catalytic reactions; and (c) Removing and separating the gaseous products and char from the reactor. An apparatus for the conversion of sludges and carbonaceous materials in accordance with the above process is also described.

### FIELD OF THE INVENTION

The present invention relates to the conversion of sludges and carbonaceous materials. More particularly, the present invention relates to a process and apparatus for the production of an improved oil product from the conversion of the organic components of sewage, industrial sludges and other carbonaceous materials.

### BACKGROUND ART

Sludge is the unavoidable by-product of the treatment of sewage and other industrial wastewaters. Traditionally, disposal of such sludge is expensive and typically constitutes half of the total annual costs of wastewater treatment. Historically, the major sludge disposal options have included agricultural utilisation, land filling and incineration. Also historically, wastewater treatment plants have been designed to minimise sludge production and most effort is expended to stabilise and reduce the sludge volume prior to disposal or utilisation.

The solids component of sewage sludge comprises a mixture of organic materials composed of mostly crude proteins, lipids and carbohydrates. These solids further comprise inorganic materials such as silt, grit, clay and lower levels of heavy metals. For example, a typical raw sewage sludge comprises approximately 50 to 90% volatile matter and 25 to 40% organic carbon. Some sewage sludges already exceed current land application contaminant standards and consequently cannot be used agriculturally or are classified hazardous waste, largely due to their heavy metal and/or organochlorine content.

Many sludge processing options have been proposed in the past. Typically, such options have the potential to convert only a fraction of the organic material into usable energy and very few have been demonstrated as viable net energy producers at full scale. One example of such processes involves anaerobic digestion of sewage sludge in which approximately 35% of available organic materials is converted to produce a gas rich in methane. Other alternatives have included starved air incineration and gasification.

A significant problem associated with the above prior art processes relates to the fact that the principle usable energy-containing products are gases which are generally not easily condensable and are of a low net energy content. Accordingly, such gases are impossible or uneconomic to store and must generally be used immediately. Further, it is generally only practicable to use them to produce relatively low grade energy, such as steam, and flare them to waste during periods of little or no demand. Not surprisingly, it is preferable that any process used result in storable (liquid or solid), transportable and if possible, upgradeable energy-containing products. Such products would include synthetic oils. It is consequently desirable that there be optimum production of storable energy having any non-storable products used in the operation of the process itself.

Disposal of sewage sludge has become more problematic recently due to the fact that:
a) Agricultural use of sewage sludge is restricted by its contaminant content, particularly heavy metals and recently identified endocrine disrupting compounds and other pharmaceuticals,
b) Ocean disposal is banned,
c) Land filling is to shortly be banned in the European Union; and
d) Incineration of sewage sludge is opposed by the public primarily with respect to the “dioxin issue” (reformation of dioxin during hot flue gas cooling).

In U.S. Pat. No. 4,618,735 and 4,781,796, there are described, respectively, a process and apparatus for the conversion of sludges by heating and chemical reaction in order to obtain useful storable products therefrom, including oils. The process comprises the steps of heating dried sludge in a zone in the absence of oxygen to a temperature of at least 250° C. for the volatilisation of oil producing organic material therein, resulting in heating zone gaseous products and sludge residue, removing the said gaseous product from the heating zone; thereafter contacting heated sludge residue in a reaction zone with the removed heating zone gaseous products in the absence of oxygen at a temperature of 280° C. to 600° C. for repeated intimate gas/solid contact at temperatures sufficient to cause gas/solid contact, oil producing reactions to occur within the heating zone, gaseous products containing oil products; removing the reaction zone gaseous products from the reaction zone and separating at least the condensable oil products therefrom.

Also disclosed is an apparatus for the conversion of sludge, said apparatus comprising an enclosure establishing a heated heating zone having an inlet thereto for dried sewage sludge and separate outlets therefrom for heating zone gaseous products and residual heating zone solid products; conveyor means within the heating zone enclosure for conveying solid products from its inlet to its solid products outlet; and enclosure establishing a heated reaction zone having separate inlets thereto for gaseous and solid products and separate outlets therefrom for gaseous and solid products; conveyor means within the reaction zone enclosure for conveying solid products from its solid products inlet to its solid products outlet; a heating zone solid products outlet being connected to the reaction zone solid products inlet for the passage of solid products between them; and duct means connecting the heating zone gaseous products outlet to the reaction zone gaseous products inlet.

This process and apparatus is commonly referred to as a “single reactor” system.

In U.S. Pat. No. 5,847,248 and 5,865,956 there are disclosed, respectively, a process and apparatus based on the process and apparatus of U.S. Pat. No. 4,618,735 and 4,781,796, with the following improvements.

The gaseous products from the heating zone are transferred to either an indirect or direct condenser with oil/water separation. The resulting oil and/or non-condensable products are injected into a second reactor. Sludge residue or char from the first reactor is transferred to the second reactor by way of a transfer line. The transfer line is equipped with a valve system to ensure that no gaseous products by-pass the condensation system.

In the second reactor, which is provided with a heating means, the heated sludge residue from the first reactor is contacted with the revaporised oil or oil and non-condensable gaseous products from the condensation system in the absence of oxygen at a maximum temperature of 550° C. This contact allows reductive, heterogenic, catalytic gas/solid phase reactions for the generation of clean products and high quality oil product. A conveyor and motor is provided to move the solid product or char through the second reactor.

Gaseous products are subsequently removed from the second reactor for passage through a further condenser and oil/water separation system or for ducting to a burner for direct combustion. In the case of passage through a further condenser and oil/water separation system a volume of non-condensable gaseous product, a volume of reaction water and a volume of refined, low viscosity oil is produced. Solid products or char are removed from the second reactor by way of a further transfer line having provided therein a screw conveyor for ensuring both no air ingress into and no gaseous product egress from the second reactor. The screw conveyor is connected to a cooling system to cool the solid product or char to less than 100° C. before discharge to atmosphere.

This process and apparatus is commonly referred to as a “dual reactor” system, be it with or without intermediate oil condensation.

International Patent Application PCT/AU00/00206 (WO 00/56671) describes a process and apparatus for the conversion of carbonaceous materials having as one object thereof to provide a comparatively more simple and cost effective process and apparatus still able to provide the various advantages of the process and apparatus of U.S. Pat. No. 5,847,248 and 5,865,956. This is described as being achieved through use of a catalytic converter to receive the gaseous product of the first reactor. Gaseous product from the catalytic converter is then condensed to produce water and an oil product. The gaseous product of the reactor may be condensed, thereby separating the oil product from the gaseous products prior to introduction to the catalytic converter.

The temperature of the catalytic converter is up to 650° C., and preferably in the range of 400 to 420° C., thereby promoting reductive, catalytic gas/solid phase reactions and substantially eliminating hetero-atoms, including nitrogen, oxygen, sulphur, and halogens. The catalytic converter contains a catalyst, the catalyst being chosen from any of zeolite, activated alumina, y-aluminium oxide, silicon oxide and oxides of alkali, earth alkali and transition metals.

This is commonly referred to as a “Catalytic Converter” system.

Fundamental to each of the systems described previously is a reliance on the fact that vapour and char flowrates are a function of the sludge feed rate (“SFR”) and the fraction of sludge vapourised (f). Thus:
Vapour Flowrate=SFR*f (1)
Char Flowrate=SFR(1−f) (2)

Since all reactors described to date have positive sludge/char conveying systems, the mass of char in the reaction zone is purely a function of char flowrate and the solids retention time (SRT) of the char, which is a function of the screw speed and pitch. The mass of char in the reaction zone is thus:
Char Mass=SFR(1−f)*SRT (3)

Weight Hour Space Velocity (“WHSV”) is a parameter used in the design of some vapour-phased catalytic converter systems. Substituting equations (1) and (3) into the equation for WHSV reveals that:

$$WHSV = \frac{f}{( 1 - f ) * SRT} \qquad ( 4 )$$

Consequently, in prior art conversion reactors, the WHSV is purely a function of char SRT, for any given sludge (which defines f).

This is a major limitation of the prior art since to achieve an acceptable WHSV, very high SRT's, and thus very low conveyor speeds, of less than 1 rpm, are required. These low conveyor speeds, and the accompanying necessary very low pitch of the conveyor, provide poor mixing of the solid product and hence poor heat and mass transfer in the reactors.

A further factor apparent in the prior art that needs addressing relates to the presence of free water in the sludge. Typically sludges are commercially dried to between 10 and 5% water. In the conversion reactors this water flashes to steam, with a significant volume increase, which reduces the residence time of the oil vapours in the reactor. It would thus be advantageous, for sludges with more than 5% water, to remove this water by heating to about 105° C., prior to entry to the conversion reactors.

It is one object of the present invention to provide a process and apparatus for the conversion of sludges and carbonaceous materials that allow adequate mixing of solid product and thereby provides an acceptable WHSV when compared with the processes and apparatus of the prior art.

The preceding discussion of the background art is intended to facilitate an understanding of the present invention only. It should be appreciated that the discussion is not an acknowledgement or admission that any of the material referred to was part of the common general knowledge in Australia as at the priority date of the application.

Throughout the specification, unless the context requires otherwise, the word “comprise” or variations such as “comprises” or “comprising”, will be understood to imply the inclusion of a stated integer or group of integers but not the exclusion of any other integer or group of integers.

### DISCLOSURE OF THE INVENTION

In accordance with the present invention there is provided process for the conversion of sludges and carbonaceous materials, characterised in that the process comprises the steps of:
(a) Heating the material to be converted whilst being conveyed through a heating zone of a reactor in the absence of oxygen for the volatilisation of oil producing vapours, thereby producing both a vapour product and a solid residue or char;
(b) Contacting the vapour product and char whilst conveying that char through a reaction zone of the reactor at a determined Weight Hour Space Velocity (“WHSV”) so as to promote vapour-phase catalytic reactions; and
(c) Removing and separating the gaseous products and char from the reactor,
wherein the material and the resulting char are conveyed by way of a non-positive conveyor, and less than 5% of the material to be converted is passed from the reactor in a time less than that required to heat it to a temperature of more than about 400° C.

Preferably, the gaseous products from the reactor may be condensed to produce oil and water. The oil and water may then be separated and the oil polished to remove char fines and any free water.

Still preferably, the inventory of char within the reactor is able to be adjusted to provide the required WHSV in the reaction zone of the reactor.

Still further preferably, the heating rate in the heating zone is between about 5 and 30° C./min.

The material to be converted may preferably be conveyed through the heating and reaction zones by a conveyor having a rotational speed of at least about 1 rpm.

Preferably, the conveyor is provided with paddles and rotates such that the paddle tip speed is between about 2 and 8 m/min.

Still preferably, less than about 5% of the char inventory is passed through the reactor in less than about 40 minutes.

The dried sludge is fed to, and char removed from the reactor by a means to ensure no ingress of air into the reactor, or egress of vapours from the reactor.

The temperature of the reactor is preferably between 400 to 450° C.

The process of the present invention may further comprise the additional step of drying the material to be converted to less than 5% moisture prior to introduction to the reactor.

In accordance with the present invention there is further provided an apparatus for the conversion of sludges and carbonaceous materials, the apparatus characterised by comprising a reactor having a heating zone and a reaction zone and a means for conveying the material in a non-positive manner through both zones of the reactor in turn, the heating zone having a material inlet and the reaction zone having a material outlet and a gaseous product outlet, wherein there is further provided a retention means for retaining the material within the reactor such that a desired Weight Hour Space Velocity (“WHSV”) for the material is achieved.

Preferably, the means for conveying material is a conveyor that allows a level of back mixing of the material being conveyed.

In one form of the present invention the conveyor comprises in part an elongate shaft along at least a portion of the length of which are provided a plurality of paddles extending radially therefrom arranged to engage a bed of the material to be conveyed therethrough.

Preferably, the paddles are provided in a single row helical arrangement along the elongate shaft. The paddles preferably overlap along the length of the shaft.

The paddles are preferably spaced radially from adjacent paddles by between 30 to 90°. Still preferably, adjacent paddles are spaced apart from adjacent paddles by about 72°.

Still further preferably, every second paddle is pitched at a back angle towards the material inlet. The back angle is preferably about 10°.

Preferably, the retention means is provided in the form of a weir. The weir is preferably positioned within the reactor at a point immediately before the solids material outlet.

Still preferably, the weir is tilted or rotated within the reactor with respect to the shaft of the conveyor so as to approximate the tilt or rotation of the bed of material provided therein. In one form of the present invention the weir is rotated through 30° to the horizontal.

The weir is preferably adjustable in height.

### BRIEF DESCRIPTION OF THE DRAWINGS

The present invention will now be described, by way of example only, with reference to two embodiments thereof and the accompanying drawings, in which:

FIG. 1 is a block diagram describing a process for the conversion of sludges and carbonaceous materials in accordance with the present invention;

FIG. 2 is a cross-sectional side view of an apparatus for the conversion of sludges and carbonaceous materials in accordance with a first embodiment of the present invention;

FIG. 3 is a cross-sectional end view of the apparatus of FIG. 2 taken through line A thereof;

FIG. 4 is a cross-sectional end view of the apparatus of FIG. 2 taken through line B thereof;

FIG. 5 is a graph showing a plot of oil viscosity against WHSV demonstrating the correlation therebetween;

FIG. 6 is a cross-sectional side view of an apparatus for the conversion of sludges and carbonaceous materials in accordance with a second embodiment of the present invention, showing the level of char inventory therein;

FIG. 7 is an upper perspective sectional view of the apparatus of FIG. 6, showing the conveyor and weir located within the reactor; and

FIG. 8 is a cross-sectional end view of the apparatus of FIG. 6 taken through line A thereof.

### BEST MODE FOR CARRYING OUT THE INVENTION

A significant amount of operational data and experience has been generated by the applicants with regard to the thermal conversion of sludges, using the processes and equipment of the prior art as described hereinabove.

The “single reactor” system described hereinabove has been tested/demonstrated using continuous pilot plants, operating at scales of 1 and 40 kg/h. The “dual reactor” system described hereinabove has been tested/demonstrated, operating in both intermediate condensation (IC) and non IC modes, using continuous pilot plants operating at scales of 1 and 20 kg/h. A full-scale commercial plant, designed on the “dual reactor” basis, has been operated at sludge throughputs of up to 800 kg/h. The “catalytic converter” system described hereinabove has been tested/operated using a continuous pilot plant, operating at throughputs of up to 1 kg/h.

The commercial plant was designed and built as a dual reactor system primarily due to mechanical constraints in building a single reactor of this size. It was however, believed that the dual reactor system had other advantages, particularly the ability to easily have different solids retention times in the two reactors, which serve different functions. In addition, whilst the commercial plant was designed to operate with IC, operational issues precluded this mode of operation and the plant operated without IC.

After intensive review and interpretation of the operational data from all of these facilities the applicants now believe that the quality of the oil produced was exclusively a function of operating temperature and the Weight Hour Space Velocity (“WHSV”) achieved in the second reactor (or the reaction zone of single reactor systems). As noted hereinabove, the WHSV is a parameter used for the design of vapour-phased catalytic converter systems.

The WHSV is defined as the mass flow rate of the vapours to be converted divided by the mass of the catalyst in contact with the vapours. For the sludge conversion systems described above, the WHSV is thus:

$$\frac{\begin{matrix}Mass Flowrate of Vapours ( kg / h ) in Second Reactor \\ ( or Reaction Zone of Single Reactor Systems )\end{matrix}}{\begin{matrix}Mass of Char ( kg ) in Second Reactor \\ ( or Reaction Zone of Single Reactor Systems )\end{matrix} }$$

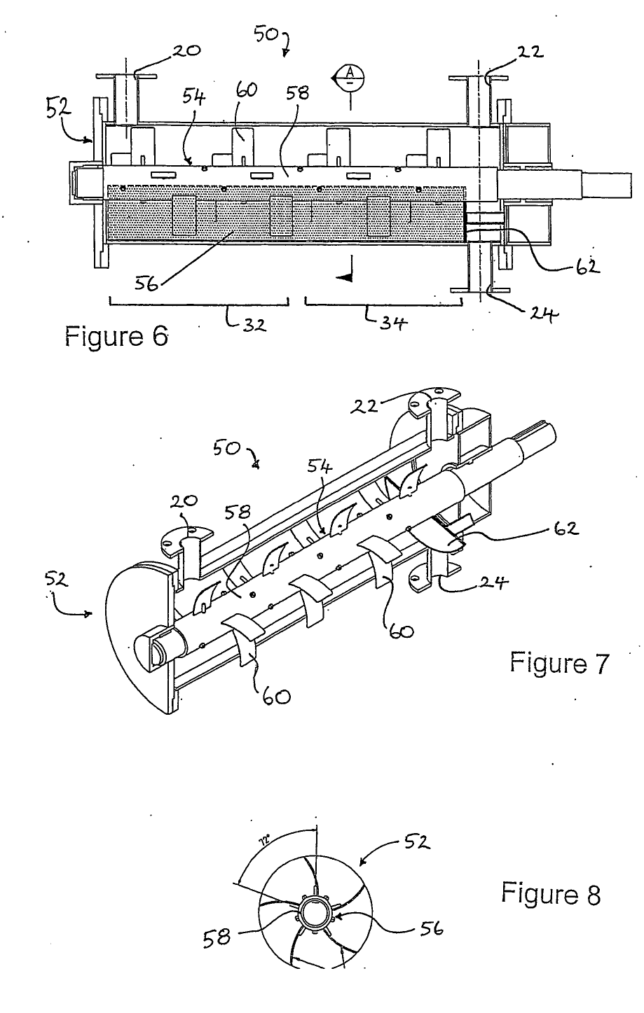

Oil viscosity data as a function of WHSV, from three different conversion systems, using two different sludges is shown in FIG. 5. As can be seen, there is a very good correlation between oil viscosity and WHSV, using reactors operating at throughputs from 1 kg to 800 kg/h. The data in FIG. 5 was obtained at an operating temperature of 400° C. FIG. 5 confirms clearly that WHSV is the parameter which controls oil viscosity, irrespective of sludge type or reactor configuration.

The process and apparatus of the present invention will now be described by way of reference to two embodiments thereof. It is to be understood that these embodiments are not to be considered as limiting, but rather as simply two examples of how both the process and apparatus of the present invention may be implemented.

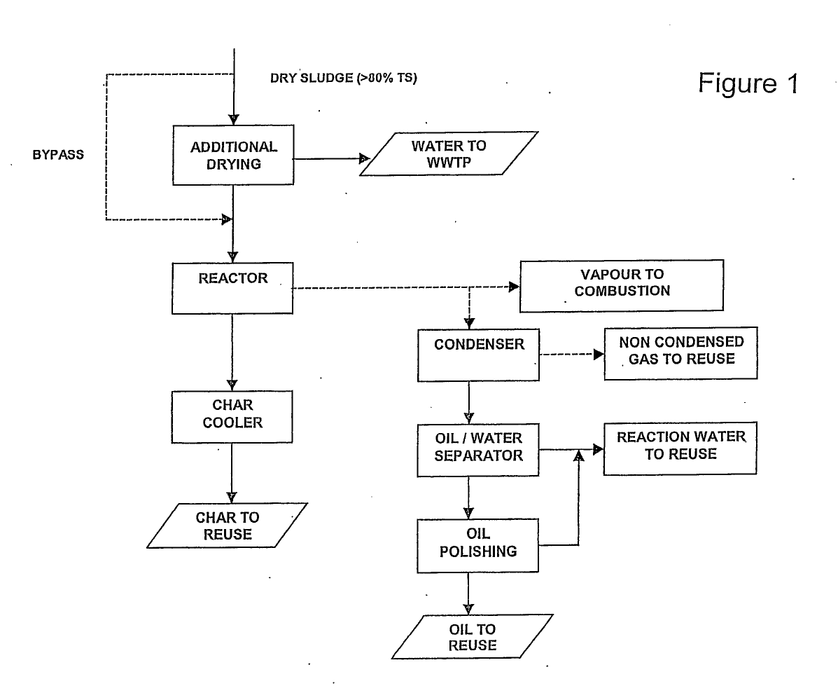

In FIG. 1 there is shown in block diagram the process of the present invention. Material to be converted, for example dry sludge with a total solids (“TS”) of greater than 80% may be fed to an additional drying step prior to introduction to a reactor. It is envisaged that materials to be converted that contain greater than 5% water will be subjected to additional drying, with the water subsequently removed being passed to a waste water treatment plant of known type.

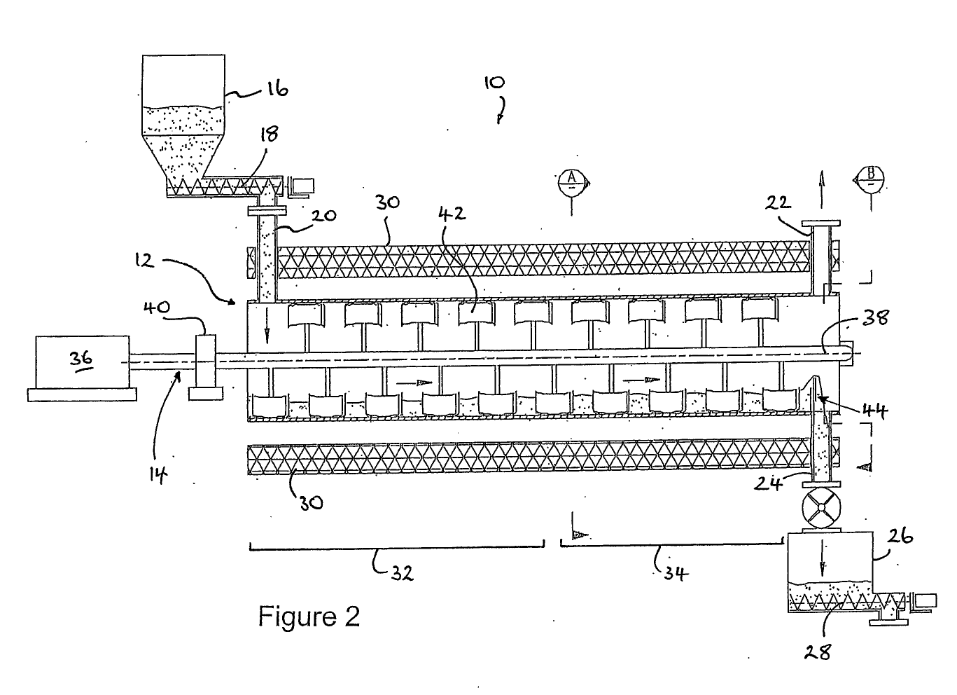

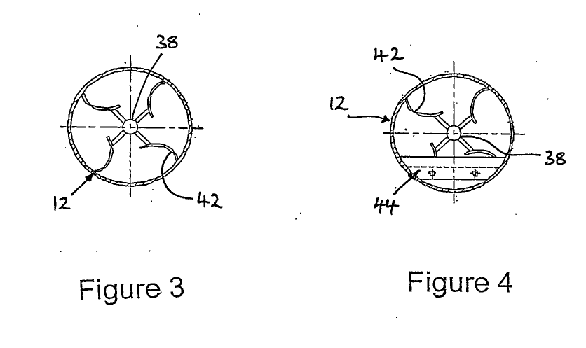

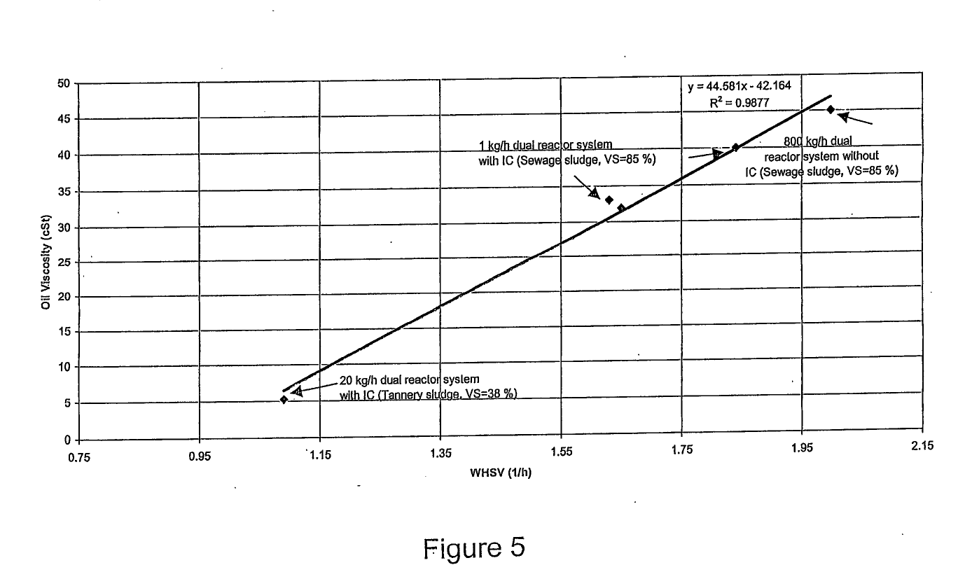

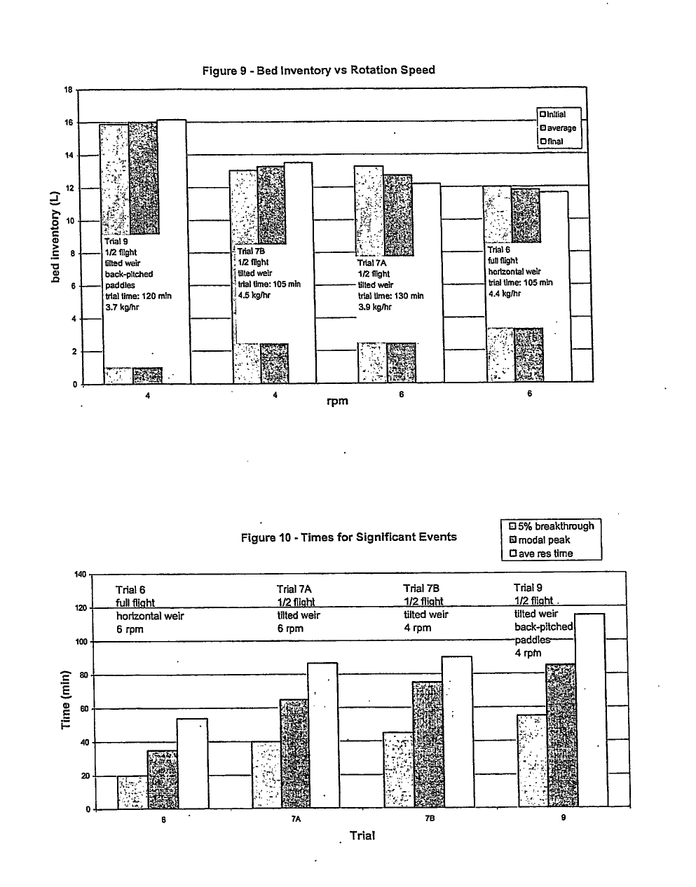

The reactor, in accordance with the present invention, to which the material to be converted is passed, will be described hereinafter with reference to either FIGS. 2 to 4, or FIGS. 6 to 8. The char produced through the heating and reaction of the material to be converted within the reactor is passed from the reactor to a char cooler after which it may be reused in the process of the present invention.

Vapour produced from the material to be converted may be passed directly to combustion or may alternatively be directed to a condenser after which the oil and water produced may be separated and the oil polished to remove char fines and any free water. The oil thus produced may be passed to reuse. Non-condensed gases from the condenser may be passed to reuse, as may be reaction water obtained from the oil/water separation step.

In FIG. 2 there is shown an apparatus 10 for the conversion of sludges and carbonaceous materials in accordance with a first embodiment of the present invention, the apparatus 10 comprising a reactor 12 and a means for conveying material through the reactor, for example a conveyor 14.

The apparatus 10 further comprises a sludge feed hopper 16, the base of which is provided with a screw conveyor 18 arranged to pass sludge to a sludge inlet 20 through which sludge may be passed into the reactor 12. Still further, the reactor 12 has provided therein a gaseous product outlet 22 and a solids material outlet 24. Char may pass from the reactor 12 to a char hopper 26, the char hopper 26 in turn being provided with a screw conveyor 28.

Additionally, the reactor 12 is provided with a heating means (not shown) and a coating of thermal insulation 30.

The reactor 12 is functionally divided into two zones, a heating zone 32 and a reaction zone 34. As sludge is passed through the inlet 20 into the reactor 12 it is conveyed from the inlet 20 through the heating zone 32 by the conveyor 14. The sludge is heated in the absence of oxygen for the volatilisation of oil producing vapours in the heating zone 32. This produces both the oil producing vapours and a solid residue, referred to as the “char”. The conveyor 14 conveys the char from the heating zone 32 and through the reaction zone 34 towards the outlet 24 and simultaneously promotes interaction of the vapours with the char so as to promote vapour-phase catalytic reactions in the reaction zone 34.

The conveyor 14 comprises a drive 36, a shaft 38 and a bearing 40 supporting the shaft 38. Within the reactor 12, the shaft 38 is provided with paddles 42 or the like which allow a level of back-mixing. It is envisaged that the levels of back-mixing promoted within the heating zone 32 and the reaction zone 34 may be different. However, the governing factor for determining the retention time within the reactor is the desired WHSV.

So as to facilitate the retention of the char within the reactor to achieve the desired WHSV, a retention means for retaining the char is provided in the form of a weir 44. The weir 44 is provided immediately before the char outlet 24. The weir 44 is provided as an adjustable-height weir such that the height of the weir 44 may be altered to achieve the desired WHSV in the reaction zone 34.

The conveyor 14 is envisaged to specifically not comprise a “positive conveyance” screw conveyor. It is further envisaged that the rotational speed is to be at least 1 rpm. Further, the heating rate within the heating zone 32 is envisaged to be between about 5 and 30° C./min.

In summary, the operational experience described above in accordance with the present invention has indicated the benefit to be gained by changing the design of the reactors to eliminate the dependency of char inventory on SRT. That is, to decouple the influence of conveyor speed on char inventory and to use the WHSV as the sole basis for the mass transfer design of the reactor.

Apparatus designed in accordance with the present invention is envisaged to overcome the limitations of the prior art systems and it is further envisaged that a single reactor will be able to handle throughputs of greater than 25 dry tpd of high volatile solids (“VS”) sludge, since it would be much smaller and manufacturing constraints would also be eliminated.

In FIGS. 6 to 8 there is shown an apparatus 50 for the conversion of sludges and carbonaceous materials in accordance with a second embodiment of the present invention.

The apparatus 50 and the apparatus 10 are substantially similar and like numerals denote like parts. The apparatus 50 comprises a reactor 52 and a conveyor means for conveying material therethrough, for example a conveyor 54.

The reactor 52 is similarly provided with a sludge inlet 20, gaseous product outlet 22 and solids material outlet 24. The feed hopper 16 and char hopper 26 of the apparatus 10 are not shown in respect of the apparatus 50, as the drive 36 and bearing 40 for the conveyor 54, and the insulation 30, are also not shown.

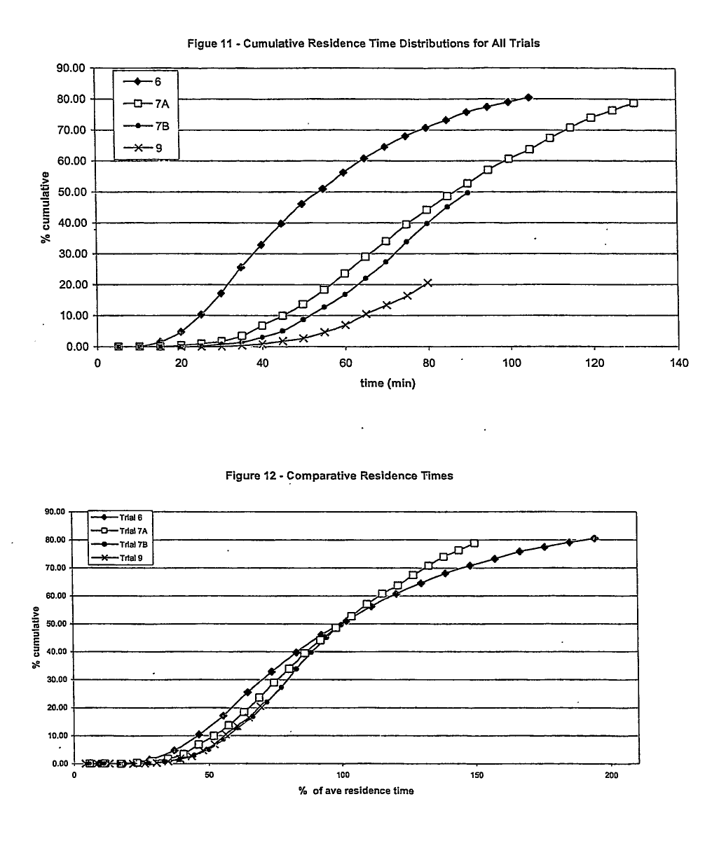

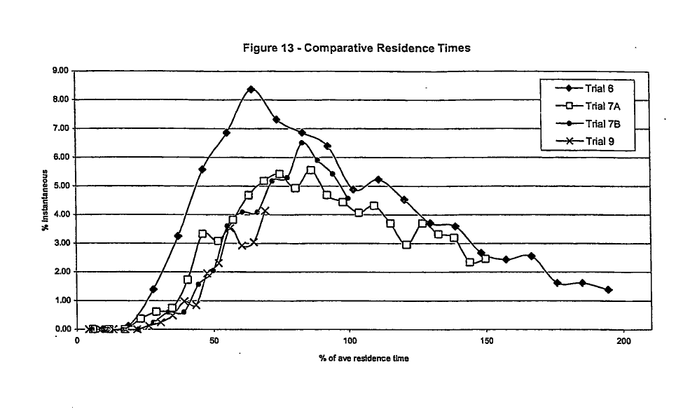

The reactor 52 is again divided into two zones, the heating zone 32 and reaction zone 34, best seen in FIG. 6. An inventory of sludge/char 56 is shown within the reactor 52. The conveyor 54 comprises a shaft 58 and a plurality of paddles 60 arranged thereon. The paddles 60 are provided in a helical arrangement about the shaft 58 and are radially curved to each form a ‘scoop’, best seen in FIGS. 7 and 8. At least a small level of back-mixing is induced by this conveyor arrangement. Adjacent paddles 60 are radially spaced at 72°. It is envisaged that adjacent paddles may be spaced apart radially by between about 30 to 90°.

The reactor 52 is again provided with a weir 62 to facilitate retention of the char 56 within the reactor 52. The weir 62 is again provided immediately before the char outlet 24. However, the weir 62 is fixed in height, but only as the desired WHSV has previously been determined. The weir 62 is also tilted or rotated with respect to the shaft 58 of the conveyor 54, at an angle of about 30° to the horizontal, so as to substantially match or mimic the angle generated in the sludge/char bed as a result of the action of the conveyor 54.

A model of the apparatus 50 was constructed for a series of tests directed at examination of shaft/paddle configuration, sludge/char bed inventory and shape, residence time and mixing characteristics.

The model consisted of a 240 mm diameter reactor shell, a conveyor shaft with paddles attached in a helical fashion, and a weir at the outlet end of the reactor, preventing the pellets from flowing out of the reactor until they reach a certain height. This model was bolted to a frame beneath an automatic feeder. A geared motor was used to drive the conveyor shaft of the reactor via a chain and sprocket arrangement. A variable speed drive (“VSD”) was used to vary the motor speed.

The procedure used for this testing was essentially:
Fill reactor with known mass of pellets
Adjust VSD to provide desired shaft rotation speed
Adjust feeder to provide desired feed rate
Begin shaft rotation and pellet feeding simultaneously
Collect all pellets leaving reactor
After half an hour of operation, measure feed rate out of reactor
If feed rate out is equal to feed rate in, reactor has reached steady state. If reactor has not reached steady state, continue monitoring feed rate out until steady state has been achieved
Continue running the reactor until steady state is reached, then shut off the pellet feed and shaft rotation simultaneously
Record the loadcell reading on the automatic feeder
Measure the total mass of pellets displaced from reactor

The mass of pellets accumulated in or depleted from the bed can now be calculated, and the final bed inventory at steady state can be found.

The next stage was to find the residence time distribution, for which the steps were essentially:
Place known mass of coloured pellets inside reactor, below entrance of feed inlet
Begin shaft rotation and pellet feed simultaneously
Collect pellets leaving reactor in five minute fractions
Continue until at least twice the theoretical residence time
Shut off the pellet feed and shaft rotation simultaneously
Count out and weigh the coloured pellets in each five minute fraction

At this point, the pellets inside the reactor were weighed out to obtain the bed inventory at the end of the trial. The paddle and weir configuration could also be changed, depending on the requirements. This was not always necessary, in which case the reactor remained on the stand, and the operating conditions (shaft speed, pellet feed rate) were changed, and the procedure repeated from the beginning.

The reactor configurations and operating conditions used for each trial are summarised in Table 1 below:

TABLE 1
Shaft Configurations and Operating
Conditions For Experimental Trials

| | Actual | Shaft | | |
|---|---|---|---|---|
| | Feed Rate | Speed | | Paddle |
| Trial | (kg/hr) | (rpm) | Number of Paddles | Configuration |
| 6 | 4.4 | 6 | 1 entire flight | all at 0° |
| | | | weir-end paddle | |
| | | | removed horizontal | |
| | | | weir | |
| 7A | 3.9 | 6 | half a flight | all at 0° |
| | | | weir-end paddle | |
| | | | removed weir | |
| | | | rotated | |
| 7B | 4.5 | 4 | half a flight | all at 0° |
| | | | weir-end paddle | |
| | | | removed weir | |
| | | | rotated | |
| 9 | 3.7 | 4 | half a flight | every second |
| | | | weir-end paddle | paddle back- |
| | | | removed weir | pitched 10°, |
| | | | rotated | first paddle |
| | | | | forward-pitched |
| | | | | 10° |

Only successful trials were selected for analysis—hence the odd numbering system.

### Bed Inventory

The design bed inventory for the model reactor is 14 L. That is, the inventory is designed as a particular volume of pellets in the reactor. The mass of pellets is then a function of the volume of the bed and the bulk density of the pellets. The bulk density of the pellets was only measured for Trial 7B (500 kg/m³) and Trial 9 (426 kg/m³). That of the pellets used in Trials 6 and 7A must be assumed to be 500 kg/m³. It is expected that this is valid, as pellets from the same batch were recycled and used for most of the trials, and only replaced towards the end of the testing.

If it is assumed that the bulk density of the pellets inside the reactor was similar to their measured bulk density, the bed inventory for each trial can be calculated from the total mass of pellets inside the bed at steady state. The mass of pellets in the bed once it had reached steady state (“before” the residence time trial) and at the end of the test (“after” the residence time trial) varied. Both of these results, as well as a their mean average, were used to calculate bed inventory, as shown in FIG. 9.

Interpretation of these results is complicated by the changes in bed inventory over time. The reactor appears to be emptying in Trials 6 and 7A, and filling in Trials 7B and 9. The initial values for bed inventory were used for comparison, as the approach to steady state took approximately the same amount of time (˜1 hr) for each trial.

The difference in initial bed inventory between Trial 9 and Trial 7B is ˜3 L. This is very large, and suggests that back-pitching the paddles increases initial bed inventory, however it is difficult to separate the effect of the much lower bulk density and the different reactor configuration. Due to the small change in bed inventory over time, the reactor configuration and operating conditions for Trial 9 would appear to be optimal for steady operation.

The increase in bed inventory between Trial 6 and Trial 7A is approximately 1 L. The increase in bed inventory between Trials 7A and 7B is <0.3 L. This means that shaft speed had little to no influence on initial bed inventory, whereas the number of paddles and/or the rotated weir had a much greater effect. Between Trial 6 and Trial 7A, half a flight of paddles was removed from the reactor, and the weir was tilted to match the angle of the bed. These two changes could both have had a major effect on their own, so assigning the increase in inventory to only one of these altered variables is not really valid. This means that it is hard to assess from these results whether the angle of the weir is a vital variable for operation of the new reactor. However, it was clear that the dead zone behind the weir is significantly reduced by angling the weir in line with the bed. This means that most of the bed is active, with little build-up of old, dusty pellets before the outlet. In fact, from observation, a tilted weir creates a more ‘useful’, regular bed (near the outlet).

The change in bed inventory over time is definitely influenced by the shaft speed and the paddle configuration. The bed was depleted during Trial 7A, when the shaft speed was 6 rpm, whereas in Trial 7B (4 rpm), pellets accumulated in the reactor. There is a difference in feed rate, however the total amount fed to the reactor during Trial 7B is less than that fed to the reactor during Trial 7A, and the inventory still increases. The only difference between these two trials is rotational speed, thus it would seem that, as speed decreases, the rate at which the pellets are fed out of the reactor decreases.

The aim of the weir was to provide 14 L of pellet build-up in the reactor, providing a 30% coefficient of fill. Therefore, the desired coefficient of fill was almost achieved by the configurations in Trials 7A & 7B and more than achieved by the configuration in Trial 9. For all these trials, the bulk density had a large effect in determining bed inventory, by influencing the shape and hence volume of the bed. The low bulk density (450-500 kg/m³) of the pellets in Trial 9 allowed the bed to build up inside the reactor, (large angle of repose), actually sitting above the level of the weir. Thus, although this configuration was the best for achieving coefficient of fill in these trials, it might not maintain such a large bed inventory with higher bulk density pellets. Higher bulk density pellets would not be able to achieve an inventory of 16 L, however it is expected that the minimum volume of 14 L could be achieved.

Thus, the first aim stated for these experiments, of finding ways to improve the coefficient of fill, has been achieved. The coefficient of fill can be increased by decreasing the number of paddles within the reactor, and angling the paddles back towards the reactor inlet. Specifically, for the Perspex model, a shaft speed ≦4 rpm, half a flight (9) of paddles, and a slight (10°) back angle to the paddles maximises the bed volume.

The effect on bed inventory caused by decreasing the number of paddles is probably not caused by the reduced volume of plastic in the reactor, but by the reduced disturbance to the bed. A parameter called “bed disturbance” is proposed. This is something such as the number of mixing events in each section of the bed per unit time. It is a function of the number of paddles and the rotation speed. Thus reducing number of paddles and rotation speed reduces “bed disturbance”. The optimum parameters for larger reactors would be different, but the rule would be essentially the same—reducing bed disturbance increases bed inventory.

Residence Time—Average Residence Times

The modal and average residence times for each trial, as well as the time at which 5% of the pellets had exited, are summarised in FIG. 10. The ‘modal’ residence time was taken as the peak in the instantaneous curve—ie the time when the most pellets exited in a five-minute fraction. The ‘average’ residence time was taken as the time when 50% of the pellets had exited the reactor.

There are two major sources of error in this comparison—possible short-circuiting during Trial 6, and over-estimation of average residence time in Trial 9.

During Trial 6, when the coloured pellets were introduced to the reactor the rotation and pellet feeding were maintained, and the coloured pellets were poured into the top of the feed inlet. When they hit the shaft, they bounced along the reactor, some of them coming to rest at least 20 cm (20% of reactor length) away from the feed inlet. This could have caused a large amount of short-circuiting, and seriously underestimated the actual residence time.

Due to insufficient time available for completing the trial, the data for Trial 9 is only available up to 20% cumulative mass. Because of this the average residence time was found by manually extrapolating the data to 50% cumulative mass, which assumed a curve shaped similarly to the previous ones. This would overestimate the residence time, if the actual curve were more ideal.

If the ideal average residence time is calculated from the bed inventory (kg) divided by the mass feed rate, the predicted ideal residence times can be calculated. These have been compared to the actual values found by experimentation in Table 2 below.

TABLE 2
Predicted vs Actual Residence Times

| | | | Predicted | Measured Average |
|---|---|---|---|---|
| | | Average Bed | Average | Residence Time |
| | Feed Rate | Inventory | Residence | (50% Cumulative) |
| Trial | (kg/hr) | (kg) | Time (hr) | (hr) |
| 6 | 4.4 | 5.91 | 1.34 | 0.90 |
| 7A | 3.9 | 6.36 | 1.63 | 1.45 |
| 7B | 4.5 | 6.64 | 1.48 | 1.50 |
| 9 | 3.7 | 6.82 | 1.84 | 1.92* |

*this value extrapolated manually

If the results of Trial 6 are disregarded, and the Trial 9 residence time is assumed to be approximately equal to the ideal predicted value, it seems clear that the pellets on average are remaining in the reactor for the predicted length of time. Thus the average residence time does follow the ideal plug flow model, although the residence time distribution does not. It is interesting to note that the results more closely approach the ideal for Trials 7B and 9, for half a flight of paddles and a shaft speed of 4 rpm. Thus, similarly to the results for bed inventory, the desired residence time can be achieved by decreasing bed disturbance (ie decreasing rotational speed and/or number of paddles).
Residence Time Distribution

In order to compare the residence time distributions between the various Trials, the instantaneous and cumulative mass fractions were plotted as functions of the average residence time. The different times at which the instantaneous results were obtained were reduced to percentages of the average residence time. This meant that the results of all four trials could be plotted on the one set of axes for comparison, as shown in FIG. 12. The non-normalised results are shown in FIG. 11.

The graph of cumulative mass % as a function of residence time, FIG. 12, clearly shows that the residence time distributions are all very similar. The curve for Trial 6 has the greatest spread of values, and is the least ideal. The results for Trial 7B and Trial 9 are the closest to ideal, with the sharpest inflection. The difference between the curves reaches a maximum of 10 mass % at 75% of the residence time, but is not particularly large.

FIG. 13 provides a graph of instantaneous mass % as a function of average residence time and shows that the last three trials are quite similar, while the results of Trial 6 are more erratic. The major difference between Trial 6 and Trials 7A to 9 is that a full flight of paddles was used for Trial 6. This may or may not have caused the poorer residence time distribution. It is thought that this was caused more by dropping the pellets into the reactor during the trial, than by the reactor configuration or operating conditions.

What is apparent from these results is that the changes in shaft rotational speed and paddle angle did not significantly affect the relative amounts of back-mixing, short-circuiting, and general pellet movement within the reactor, as the residence time distributions are essentially the same. It could be inferred that the actual flow paths did not change, just the speed with which the pellets moved along them.

The second aim stated for these experiments, of finding ways to increase residence time, has been achieved. Minimum and average residence times can be increased by reducing the number of paddles on the shaft, and by angling the paddles back towards the inlet. Residence time is also improved by increasing the bed inventory, which in turn is achieved by reducing the shaft speed.

For the model reactor, the calculated ‘ideal’ residence time was approached at speeds of less than 6 rpm, and with half a flight of paddles installed on the shaft. It is to be understood that for other reactor sizes and configurations, experimentation would be necessary to determine when a suitable residence time was reached.

Bed Shape

For all the trials, the bed was rotated at an angle of about 300 to the horizontal (ie through a diametral cross-section). This was caused by the pushing action of the paddles, which piled the pellets up against one side of the reactor. This angle was uniform along the bed, and the reactor was adapted for it by rotating the weir in the same direction.

The height of the bed along the reactor (between the inlet and outlet) did not vary much once steady state had been reached. As feed rate increased and rotation speed decreased, there was some tendency for pellets to build up at the inlet end of the reactor. In most cases this build-up reached a manageable height, which was never more than 5-8 cm above the end height. If the height difference increased beyond this, the paddles became completely submerged in the bed, causing an over torque for the drive system and resulting in the trial being aborted. This occurred during Trial 8, in which both flights of paddles were installed on the shaft. The large number of paddles caused a high level of back-mixing. When there was no feed to the system, the paddles could rotate, but as soon as pellets were fed into the reactor, they began to build up at the inlet end. This build-up, despite being cleared away several times, became unmanageable, and the torque on the shaft was significant enough to cause drive system failure. Trial 8 was aborted.

This was also the reason for the lower feed rate (4 kg/hr)—at the low shaft rotation speeds used for the experiments, larger feed rates could not be conveyed adequately, leading to excessive bed build-up.

For all the trials, the bed developed a slight ‘wave’, like a sinusoidal curve. This permanent ripple in the bed became more exaggerated as the number of paddles, and the rotation speed, decreased. Thus for Trial 6, there was only small undulation, but by Trial 9, it was very pronounced.

Bed Mixing and Back-Mixing

The pellets were mixed well into the bed by the action of the paddles. The degree of back-mixing was hard to ascertain. Whilst pellets didn't move rapidly forwards (ie towards the discharge of the reactor), there was no evidence that they were moved backwards (ie towards the inlet of the reactor), except for the double flight trial (Trial 8), which was aborted for the reasons stated. What did appear to happen was that, of each scoop of pellets collected by a paddle, 50% fell forward and 50% fell backward. This held some of the pellets in the same small area between two paddles for a period of time, before they eventually moved forward. The helical spacing of the paddles created a rolling wave that moved from the inlet of the reactor towards the discharge.

Back-mixing can be a problem for heat transfer because the flow of hot gas and cool pellets is counter-current. Thus the temperature difference between the flue gas inside the heating jacket and the pellets inside the reactor is reduced if warm pellets move back towards the inlet end of the reactor. However, as long as back-mixing only occurs within a short range, the temperature profile of the pellets is not significantly affected, and there is no detrimental effect on heat transfer. Since the pellets were usually only held in a small area by the paddles.

The two aims of the experimentation were to increase bed inventory and pellet residence time. It was found that both of these could be improved by reducing the number of paddles and slowing the shaft speed. Angling the paddles back towards the inlet also achieved significant improvements. The reactor configurations and operating conditions needed to achieve a minimum pellet breakthrough time are also known, such that the reactor can be designed to provide a minimum retention time with minimal short circuiting.

It can be seen from the above discussion that it is possible to design an apparatus and method in accordance with the present invention, with a predetermined WHSV, to ensure good mixing of dry sludge for both good heat and mass transfer, whilst also minimising ‘short circuiting’ and emptying of the sludge/char bed. Good control of sludge/char inventory was able to be achieved and most importantly, for heat transfer, less than 5% of char was passed in less than 40 minutes, which is understood by the Applicant as the time needed to heat the char to 450° C.

Paddle tip speeds of between about 2 to 8 m/min provide adequate heat and mass transfer in the 240 mm diameter model apparatus of the present invention. It is envisaged that ‘scaling-up’ the results of these investigations means that for a 1 metre diameter reactor at a feed rate of 25 tpd, a conveyor rotation of only 1 to 2 rpm is required for good heat transfer and mass transfer. Further, it is desirable to keep paddle tip speed constant to provide even mixing along the sludge/char bed.

Modifications and variations such as would be apparent to the skilled addressee are considered to fall within the scope of the present invention.

1. A process for the conversion of sludges and carbonaceous materials, characterised in that the process comprises the steps of:
(d) Heating the material to be converted whilst being conveyed through a heating zone of a reactor in the absence of oxygen for the volatilisation of oil producing vapours, thereby producing both a vapour product and a solid residue or char;
(e) Contacting the vapour product and char whilst conveying that char through a reaction zone of the reactor at a determined Weight Hour Space Velocity (“WHSV”) so as to promote vapour-phase catalytic reactions; and
(f) Removing and separating the gaseous products and char from the reactor,
wherein the material and the resulting char are conveyed by way of a non-positive conveyor, and less than 5% of the material to be converted is passed from the reactor in a time less than that required to heat it to a temperature of more than about 400° C.

2. A process according to claim 1, wherein the gaseous products from the reactor are condensed to produce oil and water.

3. A process according to claim 2, wherein the oil and water are then separated and the oil polished to remove char fines and any free water.

4. A process according to any one of claims 1 to 3, wherein the inventory of char within the reactor is able to be adjusted to provide the required WHSV in the reaction zone of the reactor.

5. A process according to any one of the preceding claims, wherein the heating rate in the heating zone is between about 5 and 30° C./min.

6. A process according to any one of the preceding claims, wherein the material is conveyed through the heating and reaction zones by a conveyor having a rotational speed of at least about 1 rpm.

7. A process according to claim 6, wherein the conveyor is provided with paddles and rotates such that the paddle tip speed is between about 2 and 8 m/min.

8. A process according to any one of the preceding claims, wherein less than about 5% of the char inventory is passed through the reactor in less than about 40 minutes.

9. A process according to any one of the preceding claims, wherein dried sludge is fed to, and char removed from the reactor, by a means to ensure no ingress of air into the reactor, or egress of vapours from the reactor.

10. A process according to any one of the preceding claims, wherein the temperature of the reactor is about 400 to 450° C.

11. A process according to any one of the preceding claims, wherein the process further comprises the additional step of drying the material to be converted to less than 5% moisture prior to introduction to the reactor.

12. An apparatus for the conversion of sludges and carbonaceous materials, the apparatus characterised by comprising a reactor having a heating zone and a reaction zone and a means for conveying the material in a non-positive manner through both zones of the reactor in turn, the heating zone having a material inlet and the reaction zone having a material outlet and a gaseous product outlet, wherein there is further provided a retention means for retaining the material within the reactor such that a desired Weight Hour Space Velocity (“WHSV”) for the material is achieved.

13. An apparatus according to claim 12, wherein the means for conveying material is a conveyor that allows a level of back mixing of the material being conveyed.

14. An apparatus according to claim 13, wherein the conveyor comprises in part an elongate shaft along at least a portion of the length of which are provided a plurality of paddles extending radially therefrom arranged to engage a bed of the material to be conveyed therethrough.

15. An apparatus according to claim 14, wherein the paddles are provided in a single row helical arrangement along the elongate shaft.

16. An apparatus according to claim 15, wherein the paddles overlap along the length of the shaft.

17. An apparatus according to any one of claims 14 to 16, wherein the paddles are spaced radially from adjacent paddles by between 30 to 90°.

18. An apparatus according to claim 17, wherein adjacent paddles are spaced apart by about 72°.

19. An apparatus according to any one of claims 14 to 18, wherein every second paddle is pitched at a back angle towards the material inlet.

20. An apparatus according to claim 19, wherein the back angle is about 10°.

21. An apparatus according to any one of claims 12 to 20, wherein the retention means is provided in the form of a weir.

22. An apparatus according to claim 21, wherein the weir is positioned within the reactor at a point immediately before the solids material outlet.

23. An apparatus according to claim 21 or 22, wherein the weir is tilted or rotated within the reactor with respect to the shaft of the conveyor so as to approximate the tilt or rotation of the bed of material provided therein.

24. An apparatus according to claim 23, wherein the weir is rotated through 30° to the horizontal.

25. An apparatus according to any one of claims 21 to 24, wherein the weir is adjustable in height.

26. A process for the conversion of sludges and carbonaceous materials substantially as hereinbefore described with reference to the accompanying figures.

27. An apparatus for the conversion of sludges and carbonaceous materials substantially as herein before described with reference to FIGS. 2 to 4, or FIGS. 6 to 8.
